(19) United States
(12) Patent Application Publication
(10) Pub. No.: US 2025/0252209 A1
(43) Pub. Date: Aug. 7, 2025

(54) SECURE COMMUNICATION OF SENSITIVE INFORMATION TO VISUALLY IMPAIRED DEVICE USERS

(71) Applicant: Visa International Service Association, San Francisco, CA (US)

(72) Inventors: Radhika Sathyanarayana, Karnataka (IN); Deepika Raju Chainani, Karnataka (IN); Varalakshmi Vivekanandan, Karnataka (IN); Nimish Jain, Karnataka (IN); Prashant Jhingran, Karnataka (IN)

(73) Assignee: Visa International Service Association, San Francisco, CA (US)

(21) Appl. No.: 18/430,504

(22) Filed: Feb. 1, 2024

(51) Int. Cl. G06F 21/62; G06F 21/31; G06F 21/60

(52) U.S. Cl. CPC G06F 21/6245; G06F 21/31; G06F 21/606

(57) ABSTRACT

Disclosed are systems and method for securely communicating sensitive information on a client device that receives sensitive information. An application running on the client device determines a positive enablement status of a screen reader on the client device and determines a negative connection status of the client device to an audio device. The client device generates a prompt to connect an audio device to the client device based on the negative connection status. The application triggers a number of wait periods and determines a persistence of the negative connection status after each period of the number of wait periods. The client device generates another prompt to input a passcode via the client device based on the persistence of the negative connection status. The system includes a terminal device or online platform, the client device, and a server coupled to the client device and the terminal device or the online platform.

### TECHNICAL FIELD

The present disclosure relates to the communication of sensitive information to client devices in a secure manner using specific systems and methods to deliver sensitive information in a secure manner that maintains user privacy and control over the data being delivered. In particular, this application discloses secure communication of sensitive information to disabled and visually impaired device users.

### SUMMARY

In one aspect, the present disclosure provides a method for securely communicating sensitive information on a client device. The method comprises receiving, by a client device, sensitive information; determining, by an application running on the client device, a positive enablement status of a screen reader on the client device; determining, by the application, a negative connection status of the client device to an audio device; prompting, by the client device, to connect an audio device to the client device based on the negative connection status determination; triggering, by the application, a number of wait periods; determining, by the application, a persistence of the negative connection status after each period of the number of wait periods; and prompting, by the client device, to input a passcode via the client device based on the persistence of the negative connection status determination.

In one aspect, the present disclosure provides a system for securely communicating sensitive information on a client device. The system comprises a terminal device or online platform; a client device comprising a wireless interface; and a server coupled to the client device and the terminal device or the online platform, wherein the server facilitates communication between the client device and the terminal device or the online platform. The client device is configured to: determine a positive enablement status of a feature or option on the client device; determine a negative connection status of the client device to an audio device based on the positive enablement status determination; trigger a number of wait periods; determine a connection status of the client device to an audio device after at least one wait period of the number of wait periods; and playing a screen reading of sensitive information, generating a prompt, terminating the number of wait periods, or continuing the number of wait periods based on the connection status after the at least one wait period.

In one aspect, the present disclosure provides a method for securely communicating sensitive information on a client device. The method comprises unmasking, by a client device, sensitive information using a multifactor authentication (MFA); detecting, by an application running on the client device, an enablement status of a screen reader/talk back feature of the client device; determining, by the application, a status of a user of the client device based on the enablement status of the screen reader/talk back feature of the client device; determining, by the application, the status of the user to be a regular user based on the enablement status being disabled; determining, by the application, the status of the user to be an impaired user based on the enablement status being enabled, based on the enablement status being enabled, the method further comprises: determining, by the application, a connection status between the client device and an audio device; and providing, by the client device, feedback based on the connection status between the client device and the audio device.

### BRIEF DESCRIPTION OF THE DRAWINGS

In the description, for purposes of explanation and not limitation, specific details are set forth, such as particular aspects, procedures, techniques, etc. to provide a thorough understanding of the present technology. However, it will be apparent to one skilled in the art that the present technology may be practiced in other aspects that depart from these specific details.

The accompanying drawings, where like reference numerals refer to identical or functionally similar elements throughout the separate views, together with the detailed description below, are incorporated in and form part of the specification, and serve to further illustrate aspects of concepts that include the claimed disclosure and explain various principles and advantages of those aspects.

The apparatuses, systems, and methods disclosed herein have been represented where appropriate by conventional symbols in the drawings, showing only those specific details that are pertinent to understanding the various aspects of the present disclosure so as not to obscure the disclosure with details that will be readily apparent to those of ordinary skill in the art having the benefit of the description herein.

FIG. 1 illustrates one example of a system for secure communication of sensitive information, according to at least one aspect of the present disclosure.

FIG. 2 illustrates another example of a system for secure communication of sensitive information, according to at least one aspect of the present disclosure.

FIG. 3 illustrates a logic flow diagram of an example method for secure communication of sensitive information, according to at least one aspect of the present disclosure.

FIG. 4 illustrates a logic flow diagram of another example method for secure communication of sensitive information, according to at least one aspect of the present disclosure.

FIG. 5 illustrates a process flow diagram of one example of a method for secure communication of sensitive information to a client device according to at least one aspect of the present disclosure.

FIG. 6 is a block diagram of a computer apparatus with data processing subsystems or components, according to at least one aspect of the present disclosure.

FIG. 7 is a diagrammatic representation of an example computer system that includes a host machine within which a set of instructions to perform any one or more of the methodologies discussed herein may be executed, according to at least one aspect of the present disclosure.

FIG. 8 illustrates a block diagram of a communication device that may be used in embodiments, according to at least one aspect of the present disclosure.

FIG. 9 illustrates a logic flow diagram of another example method for secure communication of sensitive information, according to at least one aspect of the present disclosure.

### DESCRIPTION

The following disclosure may provide exemplary systems, devices, and methods for conducting financial or online transactions, confidential data transmission, and related activities. Although reference may be made to such activities in the examples provided below, aspects are not so limited. That is, the systems, methods, and apparatuses may be utilized for any suitable purpose.

Users of technology and technological mobile devices are varied in their abilities when interacting with their devices. For example, users with visual impairments may rely on native screen readers/accessibility features or screen reading applications (collectively referred to herein as “screen reader(s)” to communicate information to them. However such screen readers and applications can pose a security risk if the reading or playback audio is of sensitive or confidential information (referred to herein collectively as “sensitive information”) since this information can be overheard by others in the vicinity or nearby physical environment.

Current technologies are insufficient and have been unable to deliver systems and methods to securely communicate sensitive information to visually impaired users of smart devices and other user devices in a secure manner. There are ongoing challenges in communication of sensitive information to visually impaired users and providing such users non-visual interaction-based authentication and sensitive information on user and client devices.

The present disclosure presents systems and methods for securely communicating sensitive information and/or authenticating information to users who may be visually impaired. The systems and methods for securely deliver or provide information to a user about financial or monetary transactions. In several aspects, the present solutions leverage a client device such as a smart device including smartphones, tablets, and watches to communicate the sensitive information securely to visually impaired users without the need of any other hardware.

In various aspects the present disclosure relates to systems and methods implemented in and integrated with financial and monetary transactions that may be part of a payment network or payment processing network (“PPN”) ecosystem. In several aspects, the solutions presented herein provide simple yet secure payment network/PPN or payment application experience for visually impaired users. In many aspects the technologies disclosed can be integrated with any existing payment network/PPN applications and/or network such as Visa™ applications to communicate sensitive information to visually impaired users.

In one general aspect, the present disclosure is directed to a system for secure communication of sensitive information for users that are visually impaired or may otherwise be characterized as persons with special needs. In regard to the latter, persons with special needs include people with physical or intellectual disabilities or behavioral difficulties. During an initial login into a secure communication system, a username and password will be shared to the users and the users will be mandated to select one of a plurality of the authentication methods (e.g., face ID, fingerprint, iris, voice, among others), that will be used for authenticating the user log in thereafter. The user should also set a PIN as a fallback mechanism.

In one general aspect, visually impaired users usually rely on screen reader/talk back features provided in their client devices (e.g., smart phones, tablets, user devices, mobile devices, and the like) to listen to what is displayed on the screen of the client device. However, this might pose a risk of eavesdropping/shoulder-surfing of sensitive information being displayed on the screen and audibly provided to the users. Accordingly, in one aspect the present disclosure provides a secure communication system for accessing the sensitive information according to the following logic/algorithm.

In one aspect, the system for secure communication of sensitive information provides a multi-factor authentication (MFA) method (biometric) to unmask the sensitive information. Post MFA, an application running on the client device detects if the screen reader/talk back is enabled or not. If the screen reader/talk back is not enabled (e.g., is OFF), the application determines that the user is a regular user and the sensitive information such as payment card details are unmasked and the user can proceed as normal.

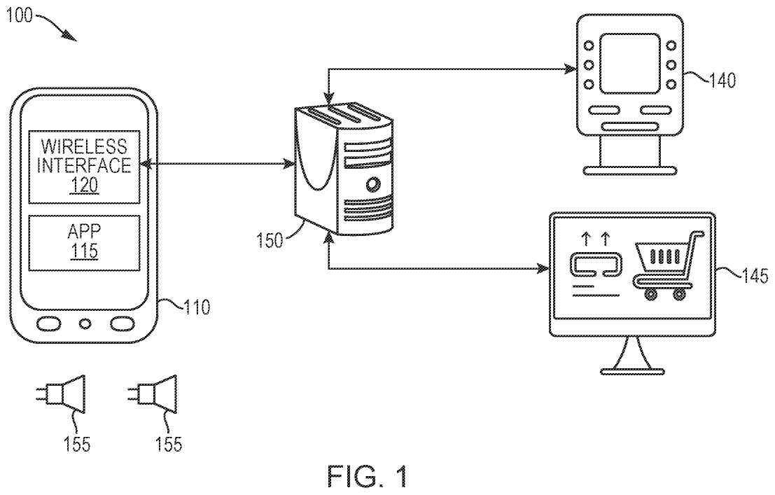

If the screen reader/talk back is enabled (e.g., is ON), the application determines that the user is visually impaired/senior citizen or otherwise characterized as a person with special needs, and the application detects if audio devices such as headphones are either connected or not connected (e.g., plugged in or not plugged in) to the client device. If the audio devices are connected to the client device, the sensitive information is read out or played for the user. If the audio devices are not connected to the client device, the user is prompted to either plug in the audio devices or bring the client device next to their ear to maintain secure communication of the sensitive information such as payment card information. In one aspect, if a client device is equipped with a proximity sensor, the application would communicate with the proximity sensor to determine whether the client device has been brought near the ear of the user and then the application would reduce the volume and read out the information for the user to hear in a secure manner. If the audio devices are not plugged in and the user does not bring the client device close to their ears after a predetermined number of times, the application prompts the user to key in the PIN (set during registration) using their braille keyboard/regular keyboard as per their preference to listen to the sensitive information. The system for secure communication of sensitive information can be a standalone application or may be integrated with existing payment network applications. Any biometric data of the user to be used in the process may be stored in the client device. Specific examples of secure communication systems and methods will now be described hereinbelow in conjunction with FIGS. 1-9.

FIG. 1 illustrates one example of a system 100 for secure communication of sensitive information to a client device, according to at least one aspect of the present disclosure. In one aspect, the system 100 according to the present disclosure includes a client device 110. The client device 110 can include a wireless interface 120 to connect to a server system 150. The server system 150 may include wireless or wired communication systems, communication networks and systems, and/or servers or server systems. The client device 110 is capable of executing one or more than one application 115, which may include and not be limited to an applet, container, module, instance, software interface, software development kit (SDK), sandbox process, an application programming interface (API), or other tool-kit or library, and can also be a complete and stand-alone program, web, hybrid, or native application for delivering and communicating sensitive information to a user of the client device 110.

In one non-limiting example, the application 115 can be one or more applications, and of various types, including a payment application, or a dedicated payment network/PPN application to facilitate payments via a specific payment network/PPN. In other non-limiting examples, the application 115 can be a digital wallet or wallet application. The application 115 can receive communications and data from the server system 150. In turn, the server system 150 may facilitate communications between the client device 110 and a point-of-sale (POS) terminal 140 (e.g., kiosk) and/or an online platform 145. The online platform 145 can include but is not limited to an online merchant platform or online marketplace (such as online store such as Best Buy™ online website or an online marketplace such as eBay™, Amazon™). The application 115 also may include an application that comprises a screen reader or undertake screen reading/playback features as described herein. By way of example, the application 115 may include a talk back screen reader accessibility feature to assist people who are blind or have low vision to interact with their client devices 110 using touch and spoken feedback. When the talk back screen reader accessibility feature is on, items displayed on the screen are outlined with a focus box, and the client device 110 provides audio cues about what is displayed on the screen to the user. In several aspects, the application 115 can make use of or utilize a native screen reader of the client device 110 to undertake screen reading of information received by the client device 110 or the application 115. In several aspects, the application 115 may be an external application running on the client device 110, or in some aspects, the application 115 may be a native application running on the client device 110.

The system 100 also may comprise one or more than one audio device 155 that can be coupled with or recognized by the client device 110. The audio device 155 may not be currently connected to the client device 110 or turned on. The audio device 155, however, may be known to the client device 110 and can be connected to the client device 110 via a wired connection, the wireless interface 120, or any other wireless communication interface (such as, for example, Bluetooth technology) of the client device 110.

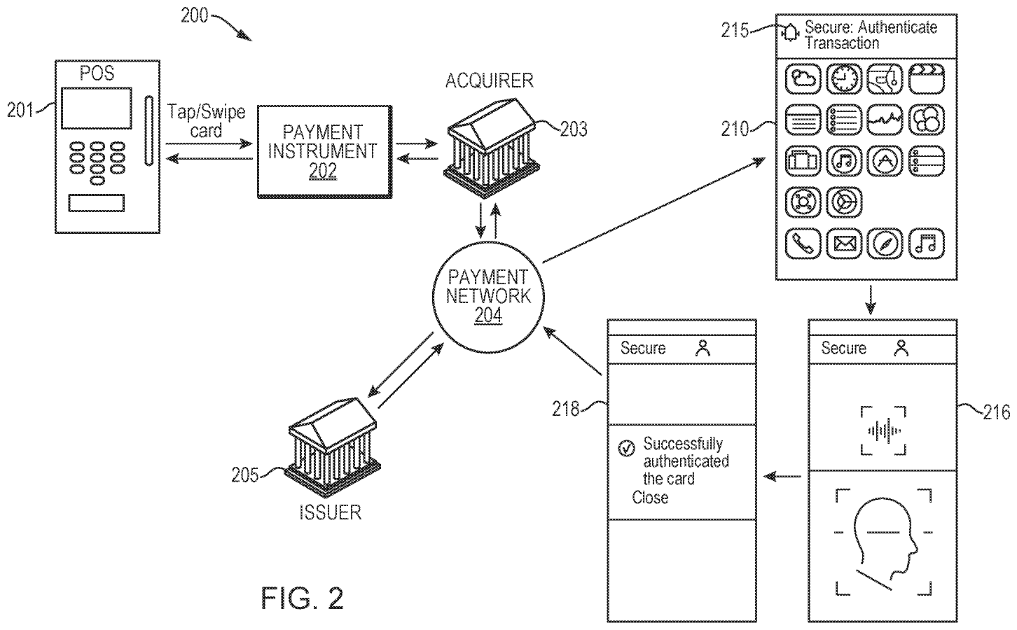

FIG. 2 illustrates another example of a system 200 for secure communication of sensitive information to a client device 210 during a commercial transaction, according to at least one aspect of the present disclosure. With primary reference to FIG. 2, the system 200 can include a merchant POS terminal 201, which may correspond to the POS terminal 140 or kiosk shown in FIG. 1. To initiate a payment transaction with a merchant, the user presents a payment instrument 202 to the POS terminal 201. The payment instrument 202 can include a physical or digital payment instrument including but not limited to physical/digital cards, tokens, digital wallet, secured QR code(s), or payment accounts, for example those belonging to a payment network/PPN or a specific payment network/PPN such as Visa™, referred to herein as a payment network 204. The merchant's POS terminal 201 sends the transaction to an acquirer system 203—the merchant bank—in the form of an authorization message. The authorization message requests authorization to take the payment funds from the cardholder's account at their issuing bank and transfer the funds to the merchant's acquiring bank. The acquirer system 203 communicates and/or interfaces with the payment network 204, for example a Visa™ network. The acquirer system 203 sends the authorization message to the payment network 204 for processing. The payment network 204 rapidly routes the authorization message to an issuer system 205, which is the bank that issued the cardholder's payment instrument 202. The issuer system 205 reviews the authorization message checks the cardholder's available funds, and approves or declines the transaction. If there are adequate funds the data flow reverses along the same tracks.

Prior to approving the transaction, the payment network 204 sends an authentication request to the client device 210 to confirm the identity of the user that presented the payment instrument 202. The payment network 204 interfaces with a secure authentication transaction application 215 running on the client device 210 to authenticate the user. The payment network 204 may request additional sensitive information from the user to confirm the purchase. The secure authentication transaction application 215 may execute any of the methods and techniques described herein to enable secure communication of sensitive information through the client device 210. In the example illustrated in FIG. 2, the secure authentication transaction application 215 on the client device 210 executes a screen reader/talk back application 216 to successfully authenticate 218 the payment instrument 202.

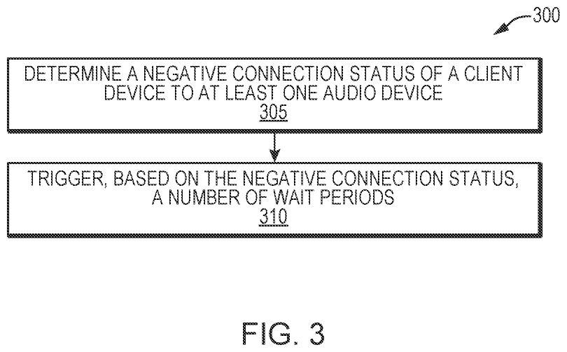

FIG. 3 illustrates a logic flow diagram of an example method 300 for secure communication of sensitive information to a client device, according to at least one aspect of the present disclosure. The various processes illustrated by the method 300 can be undertaken directly by the client device 110, 210, e.g., via an executable script that may be native to the client device. In many aspects, the processes illustrated by the method 300 may be executed by the application 115, 215 running on the client device 110, 210 as shown in FIGS. 1-2.

Referring now primarily to FIG. 3 together with FIGS. 1 and 2, the method 300 comprises determining 305 a negative connection status of a client device 110, 210 to at least one audio device 155. In several aspects, the determining 305 is undertaken based on (and/or requires) a positive enablement status of an option or feature (such as an activated/enabled screen reader/talk back application 216) on the client device 110, 210 or the application 115, 215. A negative connection status means that the audio device 155 is not currently connected to the client device 110, 210 even though the audio device 155 was previously registered, installed, or connected to the client device 110, 210, or is recognized by the client device 110, 210. In some aspects, the client device 110, 210 can be connected to multiple audio devices 155 simultaneously. The term connection comprises a physical or wireless connection of the audio device 155 to the client device 110, 210.

With continued reference primarily to FIG. 3 together with FIGS. 1 and 2, the positive enablement status of an option or feature, e.g., the activated/enabled screen reader/talk back application 216, can mean that the client device 110, 210 has the use of the option/feature enabled in one or more relevant situations, functionalities, or for specific applications executable on the client device 110, 210. In other aspects, the screen reader/talk back application 216 may be set up to be used for all functionalities of the client device 110, 210. In various aspects, the features or options are enabled for one or more applications, such as those corresponding with the application 115, 215. For example, a screen reader/talk back application 216 feature or option may be activated/enabled and its screen reader/talk back function may be applicable for one or more applications corresponding with the applications 115, 215 or for all features, functions, or applications of the client device 110, 210.

With continued reference primarily to FIG. 3 together with FIGS. 1 and 2, the method 300 comprises triggering 310 a number of wait periods based on a negative connection status of the client device 110, 210 to at least one audio device 155. The wait periods can be executed by the application 115, 215. In some aspects, each wait period is undertaken independently by the client device 110, 210 via a separate native functionality or script.

With continued reference primarily to FIG. 3 together with FIGS. 1 and 2, in several aspects, the triggering 310 comprises triggering a particular, pre-set, or predetermined number of wait periods. In other aspects, the number of wait periods is not limited as such and may be perpetual or may be terminated only by certain events or conditions. In several aspects, each wait period is of a certain defined period of time (which may be pre-set or pre-configured either by default or by a user).

With continued reference primarily to FIG. 3 together with FIGS. 1 and 2, in several aspects, during each wait period, the method 300 may include determining a connection status of the client device 110, 210 to the audio device 155 and executing, based on the connection status, at least one of playing a screen reading of the sensitive information, generating a prompt, terminating the number of wait periods, or continuing the number of wait periods. For example, between first and second wait periods, the method 300 may determine a connection to the audio device 155 and, if the audio device 155 is connected, the method 300 can execute instructions for playing a screen reader/talk back application 216 and terminating the number of wait periods to inhibit subsequent wait periods. In numerous aspects, various combinations of actions can be executed by the client device 110 210 and/or the application 115, 215 running on the client device 110, 210.

With continued reference primarily to FIG. 3 together with FIGS. 1 and 2, in numerous aspects, the method 300 also comprises determining a connection status of the client device 110, 210 to the audio device 155 and executing, based on the connection status, at least one of playing the screen reader/talk back of the sensitive information, generating a prompt, terminating the number of wait periods, or continuing the number of wall periods.

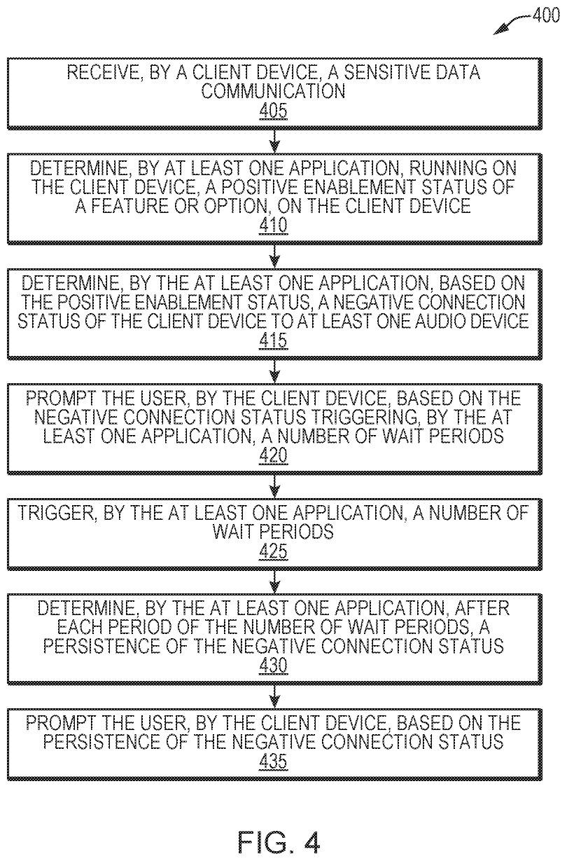

FIG. 4 illustrates a logic flow diagram of another example method 400 for secure communication of sensitive information to a client device, according to at least one aspect of the present disclosure. In various aspects, the method 400 can ensure that a private audio device 155 is connected to enable secure communication of sensitive data or information to a user of the client device 110, 210 via the private audio device 155. Any of the various processes discussed in relation to the method 400 can be executed by the client device 110, 210 directly (natively), or by one or more than one application 115, 215 or script running on the client device 110, 210.

With reference primarily to FIG. 4 together with FIGS. 1-2, in one aspect the method 400 comprises receiving 405 at least one of a request for sensitive information, an authentication request, a transaction request, sensitive information, or a combination thereof (collectively referred to herein as “sensitive information”). The sensitive information or a request for the sensitive information may be received 405 from the user, an online platform, a server, a network or a kiosk (collectively and interchangeably referred to herein as “external sources”), for example the server system 150, the POS terminal 140, and/or the online platform 145.

With continued reference primarily to FIG. 4 together with FIGS. 1 and 2, in one example, a user may initiate a transaction that requires sensitive information, where the request is sent/directed to the client device 110, 210. In other aspects, the user may use the client device 110, 210 to undertake a transaction or online process, or request sensitive information from one or more than one of the aforementioned external sources, where the sensitive information and/or an authentication request is generated and/or transmitted by one or more than one external source, for example, from or via the server system 150, the POS terminal 140, and/or the online platform 145.

With continued reference primarily to FIG. 4 together with FIGS. 1 and 2, the method 400 can optionally comprise authenticating a user of the client device 110, 210, for example, via biometric identification methods. In some aspects, the authentication can occur in response to the authentication request that is received by the client device 110, 210. In other aspects, the authentication may be accomplished by default by the application 115, 215 running on the client device 110, 210.

With continued reference primarily to FIG. 4 together with FIGS. 1 and 2, in several aspects, the method 400 comprises determining 410 a positive enablement status of a feature or option on the client device 110, 210, such as a screen reader/talk back feature. The positive enablement status may mean that a screen reader/talk back feature is enabled on one or more than one screen reader/talk back application 216, including for example the applications 115, 215 running on the client device 110, 210. The positive enablement status generally may be enabled on the client device 110, 210. The screen reader/talk back application 216 can be a standalone application (e.g., mobile, web, or hybrid application), a native application of the client device 110, 210, or it can be part of the applications 115, 215. Additionally, the screen reader/talk back application 216 can be a feature or function of the client device 110, 210, such as an accessibility feature. Positive enablement can mean that the screen reader/talk back application 216 is configured to read everything, specific or targeted portions of the sensitive information, or other information on the client device 110, 210 and/or on the applications 115, 215 running on the client device 110, 210. In various aspects, the determining 410 may include determining a positive enablement status of an accessibility feature or other application or option, or an enabled status of an indicator or feature/option indicating the availability of certain conditions or accessibility options relating to the client device and/or a user of the client device.

With continued reference primarily to FIG. 4 together with FIGS. 1 and 2, in several aspects, if the aforementioned features or options of the screen reader/talk back application 216 are not enabled, for example, the determining 410 of a positive enablement status of the screen reader/talk back application 216 is not possible and cannot occur, the method 400 may be terminated by default. In these instances, the method 400 displays/presents the sensitive information to the user via the application 115, 215 and/or the client device 110, 210 or other connected display devices without using the audio device 155.

With continued reference primarily to FIG. 4 together with FIGS. 1 and 2, in numerous aspects, the method 400 comprises determining 415, based on a positive enablement status, a negative connection status of the client device 110, 210 to at least one audio device 155. In various aspects, determining 415 can occur upon the determining 410 the positive enablement status when the screen reader/talk back feature is determined to be enabled on the client device 110, 210 or the applications 115, 215 running on the client device 110, 210. In many aspects, a negative connection status corresponds with what has been described earlier in this disclosure, especially in relation to FIG. 3, and/or is equivalent to no active wired or wireless connection to the audio device 155 even if the audio device 155 is known/recognized or previously paired with the client device 110, 210. The method 400 continues by prompting 420 the user with the client device 110, 210 and/or the application 115, 215 running on the client device 110, 210 based on the negative connection status determination. In one aspect, the prompting 420 can occur only upon the determining 415 of the negative connection status.

With continued reference primarily to FIG. 4 together with FIGS. 1 and 2, in some aspects, the prompting 420 occurs after determining 415 that the connection status is negative and/or that the screen reader/talk back application 216 feature is enabled (determining 410). In several aspects. This prompt may take the form of a notification on the client device 110, 210 instructing the user to connect the audio device 155 or announce the status of a specific connection of the audio device 155 known to the client device 110, 210 but currently disconnected therefrom. In various aspects, a prompt may result in triggering 425 a number of wait periods. In several aspects, determining 415 the connection status can trigger prompting 420 the user and triggering 425 a number of wait periods.

With continued reference primarily to FIG. 4 together with FIGS. 1 and 2, the method 400 comprises triggering 425, by the at least one application 115, 215 and/or the client device 110, 210, a number of wait periods. Each wait period may be of a certain length of time that may be predetermined, pre-set, or pre-configured. After each wait period, or in other aspects, within each wait period, the method 400 comprises determining 430 a persistence of the negative connection status. In several aspects, the method 400 comprises prompting 435 the user, by the client device 110, 210, based on the persistence of the negative connection status. Prompting 435 the user in this context can be similar, identical, or different from prompting 420 the user based on triggering due to the negative connection status. The promptings 420, 435 can be of an audible nature, or can take other forms, such as vibrations of the client device 110, 210 or other signals delivered by the client device 110, 210 and/or other devices connected to the client device 110, 210.

With continued reference primarily to FIG. 4 together with FIGS. 1 and 2, the method 400 comprises authenticating the user of the client device 110, 210. In one aspect, authenticating can occur via biometric identification information. In various aspects, the promptings 420, 435 can be undertaken directly by the client device 110, 210. In other aspects, the promptings 420, 435 can be undertaken by the one or more than one applications 115, 215 running on the client device 110, 210. The promptings 420, 435 can be undertaken based on the negative connection status and/or the persistence of the negative connection status. This may occur when confirming that the negative connection has persisted, for example, when the audio device 155 is disconnected from the client device 110, 210 or after further determinations that the audio device 155 is still disconnected. The promptings 420, 435 inform the user to connect an available audio device 155 (including a specific audio device) to the client device 110, 210.

With continued reference primarily to FIG. 4 together with FIGS. 1 and 2, in several aspects, the method 400 comprises determining, based on a positive enablement status or dependent on such status, a positive connection status of the client device 110, 210 to at least one audio device 155 (for example, an audio device that it is indeed connected via wired or wireless connection(s)). The method 400 also comprises playing, by a screen reader/talk back application 216, the sensitive information on the client device 110, 210 over the audio device 155 based on the positive connection status and/or termination of any other processes of the method 400.

With continued reference primarily to FIG. 4 together with FIGS. 1 and 2, in numerous aspects, the method 400 comprises determining, after a wait period of the number of wait periods, a positive connection status of the client device 110, 210 to at least one audio device 155 and playing a screen reading/play back of the sensitive information via the at least one audio device 155 based on the positive connection status. The application 115, 215 may terminate any remaining wait periods of the number of wait periods based on the positive connection status (since there is no longer a need for any other wait periods after determining that the audio device 155 is connected). In several aspects, additional prompts may be provided within a wait period and/or after one or more than one wait period similar to the promptings 420, 435.

With continued reference primarily to FIG. 4 together with FIGS. 1 and 2, in numerous aspects, the method 400 comprises determining, by at least one application 115, 215 running on the client device 110, 210, a negative enablement status of a feature or option, e.g., a feature of the screen reader/talk back application 216 on the client device 110, 210, and displaying sensitive information on the client device 110, 210. It may be determined, for example, that there is no need to go through the complete process or through the method 400 when a security or accessibility feature or option such as a screen reader/play back feature is not activated or enabled. In several aspects, prompting 420, 435 by at least one of the applications 115, 215 and/or the client device 110, 210 may include prompting the user of the client device 110, 210 to input a passcode via the client device 110 based on the current negative connection status (including a determined persisting negative connection status) after the last wait period of the number of wait periods or after the total number of wait periods has passed without resolution or determination that the audio device 155 is not connected to the client device 110, 210. Thereafter, prompting 420, 435 the user may include prompting or notifying the user for a passcode instead of, or in addition to, connecting to the audio device 155. The method 400 also may comprise receiving the passcode by the client device 110, 210 and displaying, by the client device 110, 210, the sensitive information based on verifying the passcode. In several aspects, the passcode may comprise a PIN, a password, an audio input, an input pattern, a touch gesture, or combinations thereof.

With continued reference primarily to FIG. 4 together with FIGS. 1 and 2, in numerous aspects, the method 400 comprises determining, by a proximity sensor of the client device 110, 210, based on a negative connection status, the position of the client device 110, 210 relative to the user and/or the audio device 155. The relative position of the client device 110, 210 is said to be within an operable position when it is located close enough for the user to hear the screen reader/playback audio. The method 400 further comprises playing a screen reader/play back of the sensitive information by the screen reader/talk back application 216 based on the relative position of the client device 110, 210 being within an operable position. The volume of the audio device 155 or spatial direction of the screen reading/play back is based on the relative position. Therefore the volume and/or the spatial direction of sound created by the audio device 155 can depend on the relative position of the client device 110, 210 to the user. A “proximity sensor” as described herein can include any smart device that can detect a nearby object, e.g., when the client device 110, 210 (e.g., smart phone) is brought near the user's ear. If the relative position of the client device 110, 210 is an inoperable position, a prompt is generated instructing the user to place the client device 110, 210 or the audio device 155 in an operable position.

With continued reference primarily to FIG. 4 together with FIGS. 1 and 2, the method 400 comprises determining, by a proximity sensor of the client device 110, 210, based on a negative connection status or a relative position of the client device 110, 210 to the user, wherein the relative position is either an operable position or an inoperable position. The method 400 further comprises triggering a prompting protocol that can include waiting period(s) and repeat determinations of the relative position of the client device 110, 210 and the user by the at least one application 115, 215 based on the relative position being within an inoperable position.

With continued reference primarily to FIG. 4 together with FIGS. 1 and 2, in various aspects, prompting 420, 435 the user to place the client device 110, 210 in a certain position or to instruct the user to place the client device 110, 210 in a different position relative to the user. The client device 110, 210, for example, itself may be stationary, such as a POS terminal 140, 201 or kiosk. In several aspects, the method 400 comprises detecting, by the proximity sensor, a change in the position of the user relative to the client device 110, 210. Accordingly, the method 400 can comprise determining, via the proximity sensor, a new position of the client device 110, 210 relative to the user and playing, for example, by the screen reader/talk back application 216 the sensitive information based on the new relative position being within the operable position. This may result by the user moving to a correct or operable position relative to the POS terminal 140, 201 or kiosk or placing the client device 110, 210 in closer proximity to the user. It will be appreciated that an operable position is one that makes it possible for the user to hear the screen reading/play back audio but makes it difficult for other individuals to listen in to the screen reading/play back audio. In several aspects, the method 400 comprises terminating, by the client device 110, 210, the prompting 420, 435 protocol based on the new relative position being within the operable position and may include playing the sensitive information.

With continued reference primarily to FIG. 4 together with FIGS. 1 and 2, the method 400 comprises, generating, by the client device 110, 210, an updated audio prompt instruction comprising at least one of a prompt instructing the user to position the client device 110, 210 in a certain position or instructing the user to move to a different user position based on the new relative position being within an inoperable position. The method 400 can further comprise playing a screen reader/play back audio message of the sensitive information, by the screen reader/talk back application 216 based on the relative position being within an operable position.

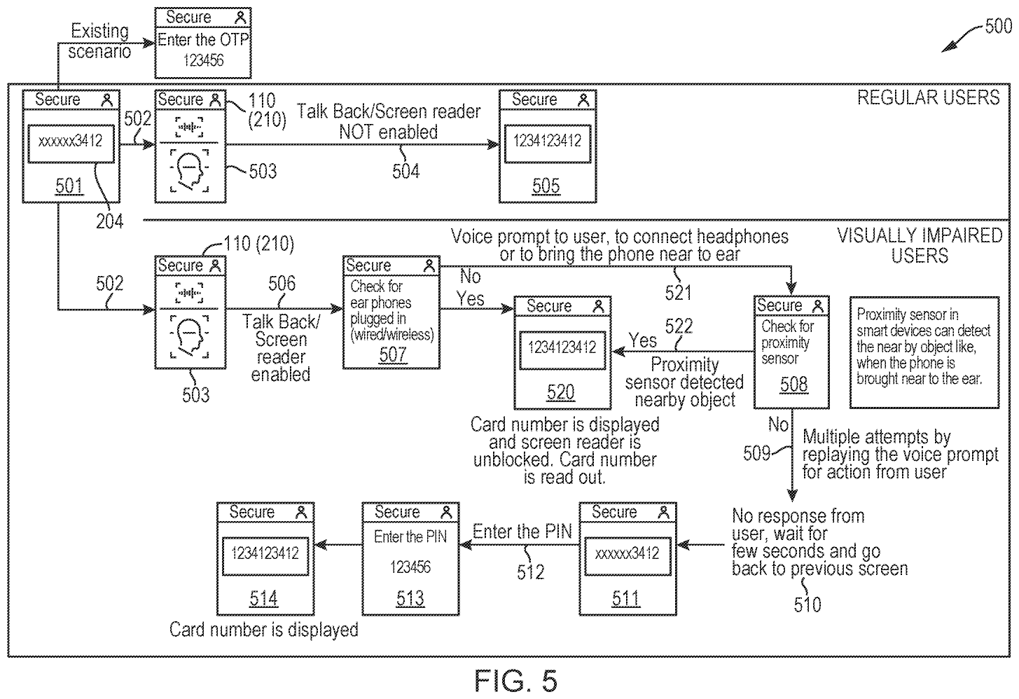

FIG. 5 illustrates a process flow diagram of one example of a method 500 for secure communication of sensitive information to a client device according to at least one aspect of the present disclosure. Now with reference primarily to FIG. 5 together with FIGS. 1 and 2, the processes described herein in relation to FIG. 5 can be undertaken by the client device 110, 210 natively, or via one or more applications 115, 215 running on the client device 110, 210, or combinations thereof. In several aspects, the method 500 comprises transmitting 502 sensitive information (or a data package comprising sensitive information) from a server 501 to the client device 110, 210 configured with a secure communication application such as the screen reader/talk back application 503. In various aspects, the sensitive information may be transmitted 502 by a client device separate from the client device 110, 210, a kiosk, a POS terminal 140, 201, an online portal, a payment network 204, or any combination thereof. The sensitive information is received by the client device 110, 210 (for example a computing device, or a smart device such as mobile phone or tablet) application 503. In one aspect, the application 503 executes instructions to implement a screen reader/talk back algorithm that provides audible feedback of information displayed on the client device 110, 210 to the user. In one aspect, the application 503 is configured to execute a screen reader/talk back application 216. Those skilled in art will appreciate that the application 503 may execute other algorithms. As previously discussed, a screen reader/talk back application 216 is an accessibility feature that assists blind or visually impaired people (e.g., people who have low vision) to interact with their client devices 110, 210 using touch and spoken feedback.

Once the transmission 502 is received by the screen reader/talk back application 503 on the recipient client device 110, 210, software on the recipient client device 110, 210 or the screen reader/talk back application 503, determines whether a specific option or feature of the client device 110, 210 or screen reader/talk back application 503 is enabled. This determination could be based on the content or instructions transmitted 502 within or as part of the data package that is received by the client device 110, 210. Non-limiting examples of specific options or features include security features, accessibility features, options, settings, applications, screen reader, talk back feature, or combinations thereof.

With continued reference to FIG. 5, together with FIGS. 1 and 2, in several aspects, if it is determined 504 that the specific option or feature is not enabled and/or activated on the client device 110, 210 or the application 503, then the sensitive information is displayed or made accessible 505 on the client device 110, 210 or application 503 running on the client device 110, 210. If, however, it is determined 506 that the specific feature is enabled or active on the client device 110, 210, then the client device 110, 210 or application 503 determines 507 whether the audio device 155 is plugged in or connected to the client device 110, 210 or the application 503. As previously discussed, the audio device includes, for example, wired or wireless, headphones, earphones, ear buds, speakers, or other audio devices.

With continued reference to FIG. 5, together with FIGS. 1 and 2, in various aspects, if a screen reader/talk back feature of the application 503 is turned on or available, then the method 500 determines that the user is visually impaired and/or requires special needs. In many aspects, the client device 110 or application 503 detects or determines 507 whether or not the audio device 155 is plugged in. If the audio device 155 is plugged in, the sensitive information is read out, played 520, and/or otherwise displayed 514 by the audio device 155 or the client device 110, 210. If the audio device 155 is not connected, the user is prompted 521 to connect the audio device 155. In several aspects, the method 500 includes determining 508 checking a position or distance of the client device 110, 210 and/or the audio device 155 (regardless of their connection status) via at least one proximity sensor to determine the distance or position of any of the aforementioned devices from the user. In several aspects, the range can be determined and the sensitive information read out or played 520 at a volume level adjusted for the distance or location of the aforementioned devices relative to the user. For example, if the audio device 155 is not connected and the application 503 determines, via a proximity sensor, that the client device 110, 210 (e.g., a mobile phone with built in proximity sensing functionality) is near the user's head, then the application 503 authorizes playing 520 the sensitive information from the client device 110, 210 speakers at a certain volume level based on the distance between the user and the client device 110, 210. In various aspects, if the client device 110, 210 is located too far from the user, the application 503 does not authorize playing 520 the sensitive information to maintain a level pf privacy and security. In several instances, locating the client device 110, 210 or the audio device 155 into an operable range can trigger playing 520 the sensitive information in an audible form through the speakers of the client device 110, 210. For example, placing the client device 110 near an ear of the user enables the application 503 to read out or play 520 the sensitive information at an adjusted volume based on the proximity of the client device 110, 210 to the ear of the user.

With continued reference to FIG. 5, together with FIGS. 1 and 2, in some aspects, if one or more than one audio device 155 is determined 507 to be disconnected, then a determination 508 or check may be made to determine whether the client device 110, 210 and/or the audio device 155 has a proximity sensor. In many aspects, the determination 508 also may include determining the proximity of the client device 110, 210 and/or the audio device 155 to the user as well. If it is determined 507 that the audio device 155 (e.g., earphones, ear buds, headphones) is not connected and/or it is determined 508 that there are no client devices 110, 210 and/or audio devices 155 within an acceptable or operable range, then a prompt is delivered 509 to the client device 110, 210 or is played on the client device 110, 210 (e.g., user device, mobile device, and the like). The prompt may be a voice prompt with instructions. In various aspects, the instructions may include prompting the user to locate the audio device 155 or the client device 110, 210 proximal to the user or place the audio device 155 or client device 110, 210 in a specific position or orientation. In other aspects, the instructions may include prompting the user to connect the client device 110, 210 to the audio device 155. The prompt also may be conveyed to the user in the form of vibration to capture the user's attention or haptics through the user's sense of touch. In other aspects, the prompt may be conveyed to the user in the form of a signal that can be received, perceived, and/or interpreted by the user, the client device 110, 210, the application 503, or any other device or technique.

With continued reference to FIG. 5, together with FIGS. 1 and 2, in several aspects, prompts of varying types may be delivered 509 to the user, the client device 110, 210, and/or the audio device 155. There may be a preset number of prompts that are delivered 509 as part of the method 500. In several aspects, a certain number of wait periods or pauses may be inserted between each prompt delivered 509. The number of wait periods, the length of each wait period, or the number of processes within each wait period can be set by default, or in some aspects, may be customized, predetermined, or configured. After each prompt and/or each wait period, the determinations 507, 508 can be repeated to ascertain whether the audio device 155, or other device, is connected to the client device 110, 210, or whether the audio device 155 and/or the client device 110, 210 is located within an acceptable or operable range.

With continued reference to FIG. 5, together with FIGS. 1 and 2, in various aspects, if it is determined 507 that the audio device 155 (e.g., ear buds, earphones, headphones, speakers) is indeed plugged in or connected to the client device 110, 210, then the sensitive information may be displayed or played 520 by the client device 110, 210. In one aspect, this may be implemented by unblocking a screen reader or user interface to allow the sensitive information to be displayed or played 520 on the client device 110. In several aspects, the determining 507, 508 function must be within acceptable parameters to display or play 520 the sensitive information. For example, it must be determined 507 that the audio device 155 is connected to the client device 110 and is located within an acceptable range (e.g., to a user or client device) for 520 to occur.

With continued reference to FIG. 5, together with FIGS. 1 and 2, in another example, it may be determined that the audio device 155 is plugged in/connected to the client device 110, 210, but the distance between the audio device 155 and the client device 110, 210, and/or the user, is determined 508 to be too far to adequately audibly play 520 the sensitive information. Such determination may lead to prompting the user to locate the audio device 155 within a suitable range. In some aspects, determining 507 may be undertaken without a proximity sensor determination 508 or checking the distance. In several aspects, regardless of the determining 507 outcome, a proximity sensor determination 508 of the distance between the client device 110, 210 and the audio device 155 is always undertaken.

With continued reference to FIG. 5, together with FIGS. 1 and 2, in various aspects, if no response is received from the user after a predetermined number of prompts and/or completion of a predetermined number of wait periods, a screen is displayed or otherwise provided/presented 511 to the client device 110, 210 and/or the audio device 155 prompting the user to enter a PIN or passcode. In various aspects, the PIN or passcode can be entered 512 by the user by way of a user interface 513 that may be part of the application 503 or other applications 115, 215. Once the passcode or PIN is entered 512 correctly, the sensitive information can be displayed 514 on the client device 110, 210 and/or the audio device 155 if it so configured. In several aspects, after a predetermined number of prompts or wait periods with non-compliance by the user, the client device 110, 210 or application 503 would prompt the user to key in a PIN/passcode (set during registration) using their braille keyboard/regular keyboard as per their preference to play and/or display 514 the sensitive information on the device.

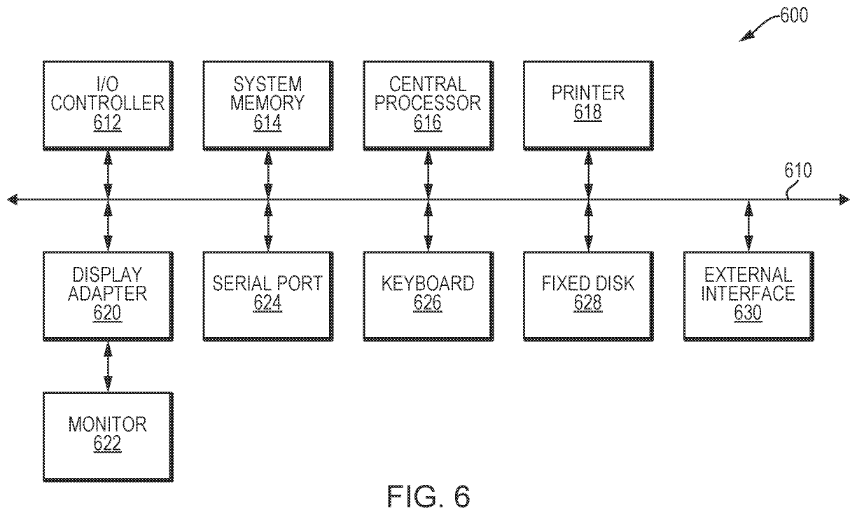

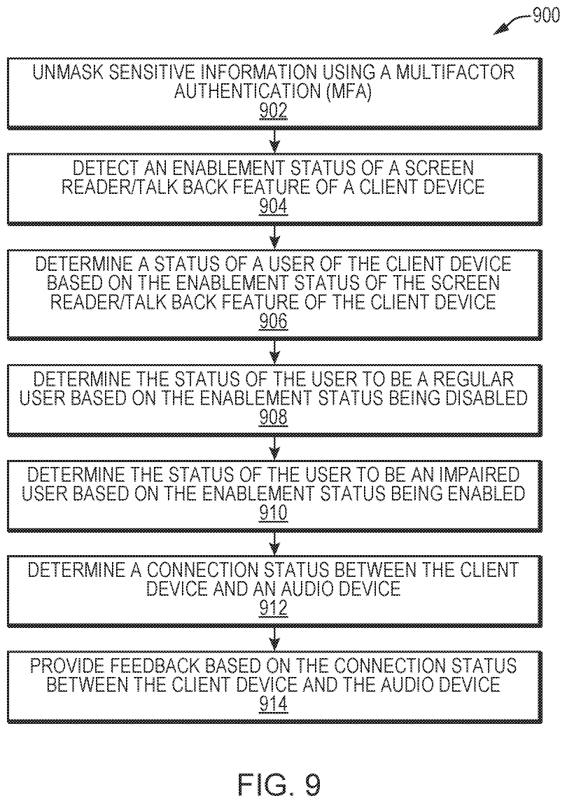

FIGS. 6-8 below describe various hardware environments suitable for implementing the systems for secure communication of sensitive information to a client device described in FIGS. 1-5. It will be understood by those skilled in the art that the hardware environments shown in FIGS. 6-8 are merely examples and those skilled in the art will appreciate that the systems 100, 200, 500 and the methods 200, 300, 400, 900 (FIG. 9) may be implemented in various hardware environments without limiting the scope of the present disclosure and appended claims.

FIG. 6 is a block diagram of a computer apparatus 600 with data processing subsystems or components, according to at least one aspect of the present disclosure. The subsystems shown in FIG. 6 are interconnected via a system bus 610. Additional subsystems such as a printer 618, keyboard 626, fixed disk 628 (or other memory comprising computer readable media), monitor 622, which is coupled to a display adapter 620, and others are shown. Peripherals and input/output (I/O) devices, which couple to an I/O controller 612 (which can be a processor or other suitable controller), can be connected to the computer system by any number of means known in the art, such as a serial port 624. For example, the serial port 624 or external interface 630 can be used to connect the computer apparatus to a wide area network such as the Internet, a mouse input device, or a scanner. The interconnection via system bus allows the central processor 616 to communicate with each subsystem and to control the execution of instructions from system memory 614 or the fixed disk 628, as well as the exchange of information between subsystems. The system memory 614 and/or the fixed disk 628 may embody a computer readable medium.

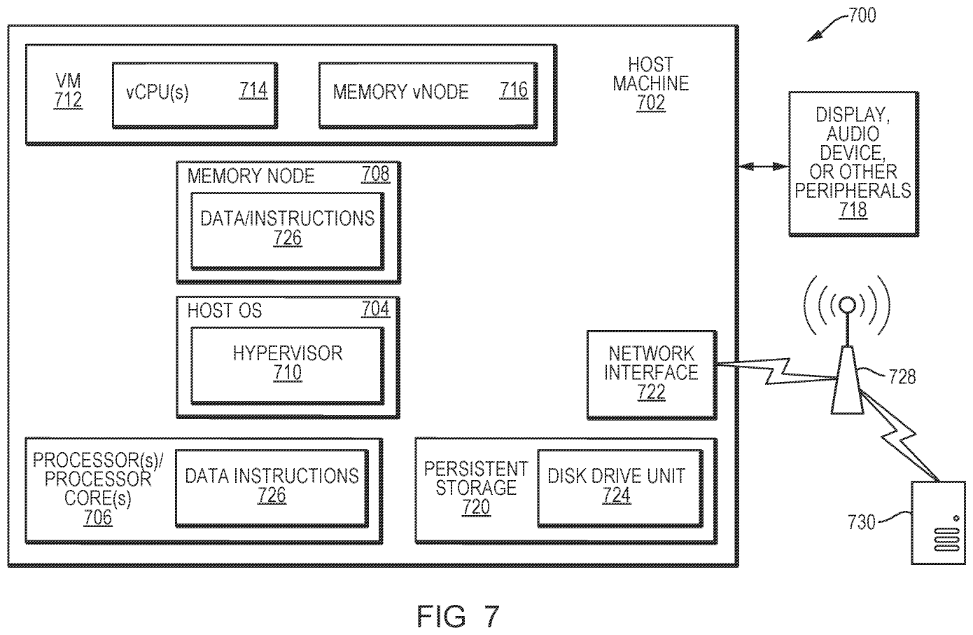

FIG. 7 is a diagrammatic representation of an example computer system 700 that includes a host machine 702 within which a set of instructions to perform any one or more of the methodologies discussed herein may be executed, according to at least one aspect of the present disclosure. In various aspects, the host machine 702 operates as a standalone device or may be connected (e.g., networked) to other machines. In a networked deployment, the host machine 702 may operate in the capacity of a server or a client machine in a server-client network environment, or as a peer machine in a peer-to-peer (or distributed) network environment. The host machine 702 may be a computer or computing device, a personal computer (PC), a tablet PC, a set-top box (STB), a personal digital assistant (PDA), a cellular telephone, a portable music player (e.g., a portable hard drive audio device such as an Moving Picture Experts Group Audio Layer 3 (MP3) player), a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 700 includes the host machine 702, running a host operating system (OS) 704 on a processor or multiple processor(s)/processor core(s) 706 (e.g., a central processing unit (CPU), a graphics processing unit (GPU), or both), and various memory nodes 708. The host OS 704 may include a hypervisor 710 which is able to control the functions and/or communicate with a virtual machine (“VM”) 712 running on machine readable media. The VM 712 also may include a virtual CPU or vCPU 714. The memory nodes 708 may be linked or pinned to virtual memory nodes or vNodes 716. When the memory node 708 is linked or pinned to a corresponding vNode 716, then data may be mapped directly from the memory nodes 708 to their corresponding vNodes 716.

All the various components shown in host machine 702 may be connected with and to each other, or communicate to each other via a bus (not shown) or via other coupling or communication channels or mechanisms. The host machine 702 may further include a video display, audio device or other peripherals 718 (e.g., a liquid crystal display (LCD), alpha-numeric input device(s) including, e.g., a keyboard, a cursor control device, e.g., a mouse, a voice recognition or biometric verification unit, an external drive, a signal generation device, e.g., a speaker,) a persistent storage device 720 (also referred to as disk drive unit), and a network interface device 722. The host machine 702 may further include a data encryption module (not shown) to encrypt data. The components provided in the host machine 702 are those typically found in computer systems that may be suitable for use with aspects of the present disclosure and are intended to represent a broad category of such computer components that are known in the art. Thus, the computer system 700 can be a server, minicomputer, mainframe computer, or any other computer system. The computer may also include different bus configurations, networked platforms, multi-processor platforms, and the like. Various operating systems may be used including UNIX, LINUX, WINDOWS, QNX ANDROID, IOS, CHROME, TIZEN, and other suitable operating systems.

The disk drive unit 724 also may be a Solid-state Drive (SSD), a hard disk drive (HDD) or other includes a computer or machine-readable medium on which is stored one or more sets of instructions and data structures (e.g., data/instructions 726) embodying or utilizing any one or more of the methodologies or functions described herein. The data/instructions 726 also may reside, completely or at least partially, within the main memory node 708 and/or within the processor(s) 706 during execution thereof by the host machine 702. The data/instructions 726 may further be transmitted or received over a network 728 via the network interface device 722 utilizing any one of several well-known transfer protocols (e.g., Hyper Text Transfer Protocol (HTTP)).

The processor(s) 706 and memory nodes 708 also may comprise machine-readable media. The term “computer-readable medium” or “machine-readable medium” should be taken to include a single medium or multiple medium (e.g., a centralized or distributed database and/or associated caches and servers) that store the one or more sets of instructions. The term “computer-readable medium” shall also be taken to include any medium that is capable of storing, encoding, or carrying a set of instructions for execution by the host machine 702 and that causes the host machine 702 to perform any one or more of the methodologies of the present application, or that is capable of storing, encoding, or carrying data structures utilized by or associated with such a set of instructions. The term “computer-readable medium” shall accordingly be taken to include, but not be limited to, solid-state memories, optical and magnetic media, and carrier wave signals. Such media may also include, without limitation, hard disks, floppy disks, flash memory cards, digital video disks, random access memory (RAM), read only memory (ROM), and the like. The example aspects described herein may be implemented in an operating environment comprising software installed on a computer, in hardware, or in a combination of software and hardware.

One skilled in the art will recognize that Internet service may be configured to provide Internet access to one or more computing devices that are coupled to the Internet service, and that the computing devices may include one or more processors, buses, memory devices, display devices, input/output devices, and the like. Furthermore, those skilled in the art may appreciate that the Internet service may be coupled to one or more databases, repositories, servers, and the like, which may be utilized to implement any of the various aspects of the disclosure as described herein.

The computer program instructions also may be loaded onto a computer, a server, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Suitable networks may include or interface with any one or more of, for instance, a local intranet, a PAN (Personal Area Network), a LAN (Local Area Network), a WAN (Wide Area Network), a MAN (Metropolitan Area Network), a virtual private network (VPN), a storage area network (SAN), a frame relay connection, an Advanced Intelligent Network (AIN) connection, a synchronous optical network (SONET) connection, a digital T1, T3, E1 or E3 line, Digital Data Service (DDS) connection, DSL (Digital Subscriber Line) connection, an Ethernet connection, an ISDN (Integrated Services Digital Network) line, a dial-up port such as a V.90, V.34 or V.34bis analog modem connection, a cable modem, an ATM (Asynchronous Transfer Mode) connection, or an FDDI (Fiber Distributed Data Interface) or CDDI (Copper Distributed Data Interface) connection. Furthermore, communications may also include links to any of a variety of wireless networks, including WAP (Wireless Application Protocol), GPRS (General Packet Radio Service), GSM (Global System for Mobile Communication), CDMA (Code Division Multiple Access) or TDMA (Time Division Multiple Access), cellular phone networks, GPS (Global Positioning System), CDPD (cellular digital packet data), RIM (Research in Motion, Limited) duplex paging network, Bluetooth radio, or an IEEE 802.11-based radio frequency network. The network 728 can further include or interface with any one or more of an RS-232 serial connection, an IEEE-1394 (Firewire) connection, a Fiber Channel connection, an IrDA (infrared) port, a SCSI (Small Computer Systems Interface) connection, a USB (Universal Serial Bus) connection or other wired or wireless, digital or analog interface or connection, mesh or Digi® networking.

In general, a cloud-based computing environment is a resource that typically combines the computational power of a large grouping of processors (such as within web servers) and/or that combines the storage capacity of a large grouping of computer memories or storage devices. Systems that provide cloud-based resources may be utilized exclusively by their owners or such systems may be accessible to outside users who deploy applications within the computing infrastructure to obtain the benefit of large computational or storage resources.

The cloud is formed, for example, by a network of web servers that comprise a plurality of computing devices, such as the host machine 702, with each server 730 (or at least a plurality thereof) providing processor and/or storage resources. These servers manage workloads provided by multiple users (e.g., cloud resource customers or other users). Typically, each user places workload demands upon the cloud that vary in real-time, sometimes dramatically. The nature and extent of these variations typically depends on the type of business associated with the user.

It is noteworthy that any hardware platform suitable for performing the processing described herein is suitable for use with the technology. The terms “computer-readable storage medium” and “computer-readable storage media” as used herein refer to any medium or media that participate in providing instructions to a CPU for execution. Such media can take many forms, including, but not limited to, non-volatile media, volatile media, and transmission media. Non-volatile media include, for example, optical or magnetic disks, such as a fixed disk. Volatile media include dynamic memory, such as system RAM. Transmission media include coaxial cables, copper wire and fiber optics, among others, including the wires that comprise one aspect of a bus. Transmission media can also take the form of acoustic or light waves, such as those generated during radio frequency (RF) and infrared (IR) data communications. Common forms of computer-readable media include, for example, a flexible disk, a hard disk, magnetic tape, any other magnetic medium, a CD-ROM disk, digital video disk (DVD), any other optical medium, any other physical medium with patterns of marks or holes, a RAM, a PROM, an EPROM, an EEPROM, a FLASH EPROM, any other memory chip or data exchange adapter, a carrier wave, or any other medium from which a computer can read.

Various forms of computer-readable media may be involved in carrying one or more sequences of one or more instructions to a CPU for execution. A bus carries the data to system RAM, from which a CPU retrieves and executes the instructions. The instructions received by system RAM can optionally be stored on a fixed disk either before or after execution by a CPU.

Computer program code for carrying out operations for aspects of the present technology may be written in any combination of one or more programming languages, including an object oriented programming language such as Java, Smalltalk, C++, or the like and conventional procedural programming languages, such as the “C” programming language, Go, Python, or other programming languages, including assembly languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

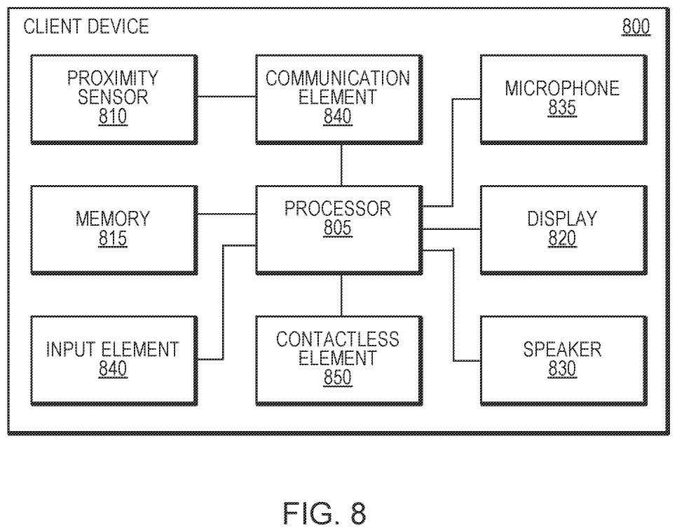

FIG. 8 illustrates a block diagram of a client device 800 that may be used in various embodiments of the present disclosure. The client device 800 is representative of the client device 110, 210 described in connection with FIGS. 1, 2, and 5, and may be a cell phone, a feature phone, a smart phone, a satellite phone, mobile device, or a computing device having a phone capability.

The client device 800 may include a processor 805 (e.g., a microprocessor or microcontroller) for processing the functions of the client device 800 and a display 820 to allow a user to see the phone numbers and other information and messages. The client device 800 further may include an input element 825 to allow a user to input information into the device (e.g., input buttons, touch screen, etc.), a speaker 830 to allow the user to hear voice communication, music, etc., and a microphone 835 to allow the user to transmit his or her voice through the client device 800. The processor 805 of the client device 800 may connect to a memory 815. The memory 815 may be in the form of a computer-readable medium that stores data and, optionally, computer-executable instructions.

With reference now to FIG. 8 together with FIGS. 1, 2, and 5, the client device 800 also may include a communication element 840 for connection to communication channels (e.g., a cellular telephone network, data transmission network, Wi-Fi network, satellite-phone network, Internet network, Satellite Internet Network, etc.), and in particular, to a token provider server computer and a mobile communication network. The communication element 840 may include an associated wireless transfer element, such as an antenna. The communication element 840 may include a subscriber identity module (SIM) in the form of an integrated circuit that stores an international mobile subscriber identity and the related key used to identify and authenticate a subscriber using the client device 800. One or more subscriber identity modules may be removable from the client device 800 or embedded in the client device 800.

The client device 800 further may include a contactless element 850, which is typically implemented in the form of a semiconductor chip (or other data storage element) with an associated wireless transfer element, such as an antenna. The contactless element 850 may be associated with (e.g., embedded within) the client device 800 and data or control instructions transmitted via a cellular network, such as for example, a mobile communication network, and may be applied to the contactless element 850 by means of a contactless element interface (not shown). The contactless element interface may function to permit the exchange of data and/or control instructions between mobile device circuitry (and hence the cellular network) and the contactless element 850.

The contactless element 850 may be capable of transferring and receiving data using a near field communications (NFC) capability (or near field communications medium) typically in accordance with a standardized protocol or data transfer mechanism (e.g., ISO 14443/NFC). Near field communications capability is a short-range communications capability, such as radio-frequency identification (RFID), Bluetooth, infra-red, or other data transfer capability that can be used to exchange data between the client device 800 and an interrogation device. Thus, the client device 800 may be capable of communicating and transferring data and/or control instructions via both a cellular network and near field communications capability.

The data stored in the memory 815 may include: operation data relating to the operation of the client device 800, personal data (e.g., name, date of birth, identification number, etc.), financial data (e.g., bank account information, a bank identification number (BIN), credit or debit card number information, account balance information, expiration date, loyalty provider account numbers, tokens, etc.), transit information (e.g., as in a subway or train pass), access information (e.g., as in access badges), etc. A user may transmit this data from the client device 800 to selected receivers.

The client device 800 may include by a proximity sensor 810 to detect a position of the client device 110, 210 relative to the user and/or the audio device 155. The proximity sensor 810 can include any smart device that can detect an object located proximal to or near the client device 800.

The client device 800 may be, amongst other things, a notification device that can receive alert messages and access reports, a portable merchant device that can be used to transmit control data identifying a discount to be applied, as well as a portable consumer device that can be used to make payments.

FIG. 9 illustrates a logic flow diagram of another example method 900 for secure communication of sensitive information to a client device 110, 210, 800, according to at least one aspect of the present disclosure. The method 900 will now be described with reference to FIG. 9 together with FIGS. 1, 2, 5, and 8. According to one aspect of the method 900 for securely communicating sensitive information the client device 110, 210, 800 unmasks 902 sensitive information using a multifactor authentication (MFA). An application 115, 215 running on the client device 110, 210, 800 detects 904 an enablement status of a screen reader/talk back feature of the client device 110, 210, 800. The application 115, 215 determines 906 a status of a user of the client device 110, 210, 800 based on the enablement status of the screen reader/talk back feature of the client device 110, 210, 800. The application 115, 215 determines 908 the status of the user to be a regular user based on the enablement status being disabled. The application 115, 215 determines 910 the status of the user to be an impaired user based on the enablement status being enabled. When the enablement status is enabled, the application 115, 215 determines 912 a connection status between the client device 110 and an audio device 155, 830 (speaker). The client device 110, 210, 800 provides 914 feedback based on the connection status between the client device 110, 210, 800 and the audio device 155.

In accordance with one aspect of the method 900, if the audio device 155 is not connected to the client device 110, 210, 800—the client device 110, 210, 800 prompts the user to “either connect the client device 110, 210, 800 to the audio device 155” or bring the client device 110, 210, 800 next to the ear of the user. The client device 110, 210, 800 reads out the sensitive information based on the connection status between the client device 110, 210, 800 and the audio device 155 being connected. In accordance with another aspect of the method 900, the client device 110, 210, 800 issues a prompt to connect the audio device 155 to the client device 110, 210, 800 or to locate the client device 110, 210, 800 close to an ear of a user of the client device 110, 210, 800.

The client device 110, 210, 800 reads out the sensitive information based on the connection status between the client device 110, 210, 800 and the audio device 155 being connected. In accordance with another aspect of the method 900, the client device 110, 210, 800 issues a prompt to connect the audio device 155 to the client device 110, 210, 800 or to locate the client device 110, 210, 800 close to an ear of a user of the client device 110, 210, 800. In accordance with another aspect of the method 900, internally the proximity sensor 810 of the client device 800 would communicate to the application 115, 215 whether the client device 800 has been brought near the ear of the user and then the application 115, 215 would reduce the volume and read out the sensitive information. In accordance with one aspect of the method 900, if the user fails to (1) connect the audio device 155 to the client device 110, 210, 800 or (2) bring the client device 110, 210, 800 next to their ear, after a number of times or wait periods, the application 115, 215 prompts the user to key in the PIN (set during registration) using a braille keyboard/regular keyboard as per their preference to listen to the sensitive information.

Examples of the method according to various aspects of the present disclosure are provided below in the following numbered clauses. An aspect of the method may include any one or more than one, and any combination of, the numbered clauses described below.

Clause 1. A method for securely communicating sensitive information on a client device, the method comprising: receiving, by a client device, sensitive information; determining, by an application running on the client device, a positive enablement status of a screen reader on the client device; determining, by the application, a negative connection status of the client device to an audio device; prompting, by the client device, to connect an audio device to the client device based on the negative connection status determination; triggering, by the application, a number of wait periods; determining, by the application, a persistence of the negative connection status after each period of the number of wait periods; and prompting, by the client device, to input a passcode via the client device based on the persistence of the negative connection status determination.

Clause 2. The method of Clause 1, further comprising authenticating, by the client device, a user of the client device via multifactor authentication (MFA).

Clause 3. The method of Clause 2, wherein the MFA comprises biometric identification information of the user.

Clause 4. The method of any one of Clauses 1-3, further comprising: determining, by the application, a positive connection status of the client device to an audio device; and playing, by the screen reader, a screen reading of the sensitive information on the client device via the audio device based on the positive connection status determination.

Clause 5. The method of any one of Clauses 1-4, further comprising: determining, by the application, a positive connection status of the client device to an audio device after a period of the number of wait periods; playing, by the screen reader, a screen reading of the sensitive information on the client device via an audio device based on the positive connection status determination; and terminating, by the application, any remaining wait periods of the number of wait periods based on the positive connection status determination.

Clause 6. The method of any one of Clauses 1-5, further comprising: determining, by the application, a negative enablement status of a screen reader on the client device; and displaying, by the client device, the sensitive information on a display of the client device.

Clause 7. The method of any one of Clauses 1-6, further comprising: prompting, by the application, to input the passcode via the client device based on the persistence of the negative connection status after a last wait period of the number of wait periods; receiving, by the client device, the passcode; verifying, by the client device, the passcode; and displaying, by the client device, the sensitive information on the client device based on a verification of the passcode.

Clause 8. The method of any one of Clauses 1-7, further comprising: determining, by a proximity sensor of the client device, a relative position of the client device to a user of the client device based on the negative connection status, wherein the relative position is within an operable position; and playing, by the screen reader, a screen reading of the sensitive information by an audio device connected to the client device based on the relative position being within the operable position, wherein at least one of a volume or a spatial direction of the screen reading is based on the relative position.

Clause 9. The method of any one of Clauses 1-8, further comprising: determining, by a proximity sensor of the client device, a relative position of the client device to a user of the client device based on the negative connection status, wherein the relative position is within one of an operable position or an inoperable position; and triggering, by the application, a prompting protocol based on the relative position being within the inoperable position.

Clause 10. The method of Clause 9, wherein the prompting protocol comprises: prompting, by the client device, to position the client device in a certain position; detecting, by the proximity sensor, a change in the relative position; determining, via the proximity sensor, a new relative position of the client device to the user; playing, by the screen reader, a screen reading of the sensitive information based on the new relative position being within the operable position; and terminating, by the client device, the prompting protocol based on the new relative position being within the operable position.

Clause 11. The method of Clause 10, further comprising: generating, by the client device, an updated audio prompt instruction comprising a prompt to position the client device in a certain position or a different user position based on the new relative position being within an inoperable position.

Clause 12. The method of any one of Clauses 9-11, wherein the prompting comprises instructions to connect, move, or orientate at least one of the client device or the audio device.

Clause 13. The method of any one of Clauses 9-12, further comprising: playing, by the screen reader, a screen reading of the sensitive information based on the relative position being within the operable position.

Clause 14. A system for securely communicating sensitive information on a client device, the system comprising: a terminal device or online platform; a client device comprising a wireless interface; and a server coupled to the client device and the terminal device or the online platform, wherein the server facilitates communication between the client device and the terminal device or the online platform; wherein the client device is configured to: determine a positive enablement status of a feature or option on the client device; determine a negative connection status of the client device to an audio device based on the positive enablement status determination; trigger a number of wait periods; determine a connection status of the client device to an audio device after at least one wait period of the number of wait periods; and playing a screen reading of sensitive information, generating a prompt, terminating the number of wait periods, or continuing the number of wait periods based on the connection status after the at least one wait period.

Clause 15. The system of Clause 14, wherein the client device is further configured to connect via the wireless interface to the server to communicate with the terminal device or the online platform.

Clause 16. The system of any one of Clauses 14-15, wherein the client device is further configured to: transmit the connection status to the terminal device or the online platform; and receive an authentication request or sensitive information from the terminal device or the online platform.

Clause 17. The system of any one of Clauses 14-16, wherein the terminal device or the online platform is configured to: transmit the sensitive information to the client device based on a successful authentication of a user or a connection status of the client device to the audio device.

Clause 18. A method for securely communicating sensitive information on a client device, the method comprising: unmasking, by a client device, sensitive information using a multifactor authentication (MFA); detecting, by an application running on the client device, an enablement status of a screen reader/talk back feature of the client device; determining, by the application, a status of a user of the client device based on the enablement status of the screen reader/talk back feature of the client device; determining, by the application, the status of the user to be a regular user based on the enablement status being disabled; determining, by the application, the status of the user to be an impaired user based on the enablement status being enabled, based on the enablement status being enabled, the method further comprises: determining, by the application, a connection status between the client device and an audio device; and providing, by the client device, feedback based on the connection status between the client device and the audio device.

Clause 19. The method of Clause 18, further comprising reading out, by the client device, the sensitive information based on the connection status between the client device and the audio device being connected.

Clause 20. The method of any one of Clauses 18-19, further comprising prompting, by the client device, connect the audio device to the client device or locate the client device close to an ear of a user of the client device.

The foregoing detailed description has set forth various forms of the systems and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, and/or examples can be implemented, individually and/or collectively, by a wide range of hardware, software, firmware, or virtually any combination thereof. Those skilled in the art will recognize that some aspects of the forms disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as one or more program products in a variety of forms, and that an illustrative form of the subject matter described herein applies regardless of the particular type of signal bearing medium used to actually carry out the distribution.

Instructions used to program logic to perform various disclosed aspects can be stored within a memory in the system, such as dynamic random access memory (DRAM), cache, flash memory, or other storage. Furthermore, the instructions can be distributed via a network or by way of other computer readable media. Thus a machine-readable medium may include any mechanism for storing or transmitting information in a form readable by a machine (e.g., a computer), but is not limited to, floppy diskettes, optical disks, compact disc, read-only memory (CD-ROMs), and magneto-optical disks, read-only memory (ROMs), random access memory (RAM), erasable programmable read-only memory (EPROM), electrically erasable programmable read-only memory (EEPROM), magnetic or optical cards, flash memory, or a tangible, machine-readable storage used in the transmission of information over the Internet via electrical, optical, acoustical or other forms of propagated signals (e.g., carrier waves, infrared signals, digital signals, etc.). Accordingly, the non-transitory computer-readable medium includes any type of tangible machine-readable medium suitable for storing or transmitting electronic instructions or information in a form readable by a machine (e.g., a computer).

Any of the software components or functions described in this application, may be implemented as software code to be executed by a processor using any suitable computer language such as, for example, Python, Java, C++ or Perl using, for example, conventional or object-oriented techniques. The software code may be stored as a series of instructions, or commands on a computer readable medium, such as RAM, ROM, a magnetic medium such as a hard-drive or a floppy disk, or an optical medium such as a CD-ROM. Any such computer readable medium may reside on or within a single computational apparatus, and may be present on or within different computational apparatuses within a system or network.

Some descriptions of terms used herein are provided below.

The terms “account credential,” “account number,” or “payment credential” may refer to any suitable information associated with an account (e.g. a payment account and/or payment device associated with the account). Such information may be directly related to the account or may be derived from information related to the account. Examples of account information may include a PAN (primary account number or “account number”), user name, expiration date, CVV (card verification value), dCVV (dynamic card verification value), CVV2 (card verification value 2), CVC3 card verification values, etc. Payment credentials may be any information that identifies or is associated with a payment account. Payment credentials may be provided in order to make a payment from a payment account. Payment credentials can also include a user name, an expiration date, a gift card number or code, and any other suitable information.

The term “acquirer” typically is a business entity (e.g., a commercial bank) that has a business relationship with a particular merchant or other entity. Some entities can perform both issuer and acquirer functions. Some embodiments or aspects may encompass such single entity issuer-acquirers. An acquirer may operate an acquirer computer, which can also be generically referred to as an “acquirer” or acquirer system”.

An “application” may include any software module configured to perform a specific function or functions when executed by a processor of a computer. For example, a “mobile application” may include a software module that is configured to be operated by a mobile device. Applications may be configured to perform many different functions. For instance, a “payment application” may include a software module that is configured to store and provide account credentials for a transaction. A “wallet application” may include a software module with similar functionality to a payment application that has multiple accounts provisioned or enrolled such that they are usable through the wallet application. Further, an “application” or “application program interface” (API) refers to computer code or other data sorted on a computer-readable medium that may be executed by a processor to facilitate the interaction between software components, such as a client-side front-end and/or server-side back-end for receiving data from the client. An “interface” refers to a generated display, such as one or more graphical user interfaces (GUIs) with which a user may interact, either directly or indirectly (e.g., through a keyboard, mouse, touchscreen, etc.).

“Authentication” is a process by which the credential of an endpoint (including but not limited to applications, people, devices, process, and systems) can be verified to ensure that the endpoint is who they are declared to be.

The terms “client device” and “user device” refer to any electronic device that is configured to communicate with one or more servers or remote devices and/or systems. A client device or a user device may include a mobile device, a network-enabled appliance (e.g., a network-enabled television, refrigerator, thermostat, and/or the like), a computer, a point-of-sale (POS) system, and/or any other device or system capable of communicating with a network. A client device may further include a desktop computer, laptop computer, mobile computer (e.g., smartphone), a wearable computer (e.g., a watch, pair of glasses, lens, clothing, and/or the like), a cellular phone, a network-enabled appliance (e.g., a network-enabled television, refrigerator, thermostat, and/or the like), POS system, and/or any other device, system, and/or software application configured to communicate with a remote device or system.

As used herein, the term “communication” and “communicate” may refer to the reception, receipt, transmission, transfer, provision, and/or the like of information (e.g., data, signals, messages, instructions, calls, commands, and/or the like). A communication may use a direct or indirect connection and may be wired and/or wireless in nature. As an example, for one unit (e.g., a device, a system, a component of a device or system, combinations thereof, and/or the like) to communicate with another unit means that the one unit is able to directly or indirectly receive information from and/or transmit information to the other unit. The one unit may communicate with the other unit even though the information may be modified, processed, relayed, and/or routed between the one unit and the other unit. In one example, a first unit may communicate with a second unit even though the first unit receives information and does not communicate information to the second unit. For example, a first unit may be in communication with a second unit even though the first unit passively receives data and does not actively transmit data to the second unit. As another example, a first unit may communicate with a second unit if an intermediary unit (e.g., a third unit located between the first unit and the second unit) receives information from the first unit, processes the information received from the first unit to produce processed information, and communicates the processed information to the second unit. In some non-limiting embodiments or aspects, a message may refer to a packet (e.g., a data packet, a network packet, and/or the like) that includes data. It will be appreciated that numerous other arrangements are possible.

As used herein, the term “comprising” is not intended to be limiting, but may be a transitional term synonymous with “including,” “containing,” or “characterized by.” The term “comprising” may thereby be inclusive or open-ended and does not exclude additional, unrecited elements or method steps when used in a claim. For instance, in describing a method, “comprising” indicates that the claim is open-ended and allows for additional steps. In describing a device, “comprising” may mean that a named element(s) may be essential for an embodiment or aspect, but other elements may be added and still form a construct within the scope of a claim. In contrast, the transitional phrase “consisting of” excludes any element, step, or ingredient not specified in a claim. This is consistent with the use of the term throughout the specification.

As used herein, the term “computing device” or “computer device” may refer to one or more electronic devices that are configured to directly or indirectly communicate with or over one or more networks. A computing device may be a mobile device, a desktop computer, and/or the like. As an example, a mobile device may include a cellular phone (e.g., a smartphone or standard cellular phone), a portable computer, a wearable device (e.g., watches, glasses, lenses, clothing, and/or the like), a personal digital assistant (PDA), and/or other like devices. The computing device may not be a mobile device, such as a desktop computer. Furthermore, the term “computer” may refer to any computing device that includes the necessary components to send, receive, process, and/or output data, and normally includes a display device, a processor, a memory, an input device, a network interface, and/or the like.

Reference to “a device,” “a server,” “a processor,” and/or the like, as used herein, may refer to a previously-recited device, server, or processor that is recited as performing a previous step or function, a different server or processor, and/or a combination of servers and/or processors. For example, as used in the specification and the claims, a first server or a first processor that is recited as performing a first step or a first function may refer to the same or different server or the same or different processor recited as performing a second step or a second function.

An “interface” may include any software module configured to process communications. For example, an interface may be configured to receive, process, and respond to a particular entity in a particular communication format. Further, a computer, device, and/or system may include any number of interfaces depending on the functionality and capabilities of the computer, device, and/or system. In some embodiments or aspects, an interface may include an application programming interface (API) or other communication format or protocol that may be provided to third parties or to a particular entity to allow for communication with a device. Additionally, an interface may be designed based on functionality, a designated entity configured to communicate with, or any other variable. For example, an interface may be configured to allow for a system to field a particular request or may be configured to allow a particular entity to communicate with the system.

An “issuer” can include a payment account issuer. The payment account (which may be associated with one or more payment devices) may refer to any suitable payment account (e.g. credit card account, a checking account, a savings account, a merchant account assigned to a consumer, or a prepaid account), an employment account, an identification account, an enrollment account (e.g. a student account), etc.

The terms “issuer institution,” “portable financial device issuer,” “issuer,” “issues system,” or “issuer bank” may refer to one or more entities that provide one or more accounts (e.g., a credit account, a debit account, a credit card account, a debit card account, and/or the like) to a user (e.g., customer, consumer, and/or the like) for conducting transactions (e.g., payment transactions), such as initiating credit and/or debit payments. For example, an issuer may provide an account identifier, such as a personal account number (PAN), to a user that uniquely identifies one or more accounts associated with the user. The account identifier may be used by the user to conduct a payment transaction. The account identifier may be embodied on a portable financial device, such as a physical financial instrument, e.g., a payment card, and/or may be electronic and used for electronic payments. In some non-limiting embodiments or aspects, an issuer may be associated with a bank identification number (BIN) that uniquely identifies the issuer. As used herein “issuer system” or “issuer institution system” may refer to one or more systems operated by or operated on behalf of an issuer. For example, an issuer system may refer to a server executing one or more software applications associated with the issuer. In some non-limiting embodiments or aspects, an issuer system may include one or more servers (e.g., one or more authorization servers) for authorizing a payment transaction.

A “payment application” or “wallet application” may store credentials (e.g., account identifier, expiration date, card verification value (CVV), etc.) for accounts provisioned onto the user device. The account credentials may be stored in general memory on the mobile device or on a secure trusted execution environment (e.g., a secure element) of the user device. Further, in some embodiments or aspects, the account credentials may be stored by a remote computer and the payment/wallet application may retrieve the credentials (or a portion thereof) from the remote computer before/during a transaction. Any number of different commands or communication protocols may be used to interface with the payment application and/or wallet application in order to obtain and use stored credentials associated with each application.

The payment application or wallet application may be configured to provide credentials to an authorized software application or module on a user device. For example, a payment application may be configured to interface with a master applet in order to provide credentials to a mobile application for a transaction. For instance, the payment application may provide a software development kit (SDK) or application programming interface (API) that the master wallet applet may use to interface with the payment application and/or wallet application. The payment application and/or wallet application may be configured to provide the sensitive information in encrypted form using stored encryption keys. Thus, each payment application and/or wallet application may have different commands and/or instructions for accessing the associated credentials stored by the payment/wallet application. For instance, each payment application and/or wallet application may have a different application program interface (API) with different commands, data requirements, authentication processes, etc., for interacting with other applications operating on the user device. Accordingly, a master wallet applet may include a number of different APIs, one for each of the different payment applications and/or wallet applications that the master wallet applet is configured to interface with.

A “payment network” may refer to an electronic payment system used to accept, transmit, or process transactions made by payment devices for money, goods, or services. The payment network may transfer information and funds among issuers, acquirers, merchants, and payment device users. One illustrative non-limiting example of a payment network is VisaNet, which is operated by Visa, Inc.

A “payment processing network” or “PPN” may refer to a system that receives accumulated transaction information from the gateway processing service, typically at a fixed time each day, and performs a settlement process. Settlement may involve posting the transactions to the accounts associated with the payment devices used for the transactions and calculating the net debit or credit position of each user of the payment devices. An exemplary payment processing network is Interlink®.

The terms “point-of-sale system,” “POS system,” or “POS terminal,” as used herein, may refer to one or more computers and/or peripheral devices used by a merchant to engage in payment transactions with customers, including one or more card readers, near-field communication (NFC) receivers, radio-frequency identification (RFID) receivers, and/or other contactless transceivers or receivers, contact-based receivers, payment terminals, computers, servers, input devices, and/or other like devices that can be used to initiate a payment transaction. A POS terminal may be located proximal to a user, such as at a physical store location, or a POS terminal may be remote from the user, such as a server interacting with a user browsing on their personal computer. POS terminals may include mobile devices.

As used herein, the term “portable financial device” may refer to a payment card (e.g., a credit or debit card), a gift card, a smartcard, smart media, a payroll card, a healthcare card, a wrist band, a machine-readable medium containing account information, a keychain device or fob, an RFID transponder, a retailer discount or loyalty card, a cellular phone, an electronic wallet mobile application, a personal digital assistant (PDA), a pager, a security card, a computer, an access card, a wireless terminal, a transponder, and/or the like. In some non-limiting embodiments or aspects, the portable financial device may include volatile or non-volatile memory to store information (e.g., an account identifier, a name of the account holder, and/or the like).

A payment processing network that is “providing degraded service” satisfies one or more system degradation criteria. System degradation criteria include any condition resulting in delayed processing of an authorization request message by a payment processing network. System degradation criteria may also include failure of a payment processing network to process an authorization request message.

As used herein, the term “product” may refer to one or more goods and/or services offered by a merchant.

As used herein, the term “sensitive information” can include authentication information/request, authorization information/request, or information used for authentication, account credentials, payment numbers, payment method information and/or authorization, account details or numbers, portable financial device information, authentication information for a transaction, transaction information, usernames, passwords, confirmation messages, other credentials, and the like.

As used herein, the term “server” may include one or more computing devices which can be individual, stand-alone machines located at the same or different locations, may be owned or operated by the same or different entities, and may further be one or more clusters of distributed computers or “virtual” machines housed within a datacenter. It should be understood and appreciated by a person of skill in the art that functions performed by one “server” can be spread across multiple disparate computing devices for various reasons. As used herein, a “server” is intended to refer to all such scenarios and should not be construed or limited to one specific configuration. Further, a server as described herein may, but need not, reside at (or be operated by) a merchant, a payment network, a financial institution, a healthcare provider, a social media provider, a government agency, or agents of any of the aforementioned entities. The term “server” may also refer to or include one or more processors or computers, storage devices, or similar computer arrangements that are operated by or facilitate communication and processing for multiple parties in a network environment, such as the Internet, although it will be appreciated that communication may be facilitated over one or more public or private network environments and that various other arrangements are possible. Further, multiple computers, e.g., servers, or other computerized devices, e.g., point-of-sale devices, directly or indirectly communicating in the network environment may constitute a “system,” such as a merchant's point-of-sale system. Reference to “a server” or “a processor,” as used herein, may refer to a previously-recited server and/or processor that are recited as performing a previous step or function, a different server and/or processor, and/or a combination of servers and/or processors. For example, as used in the specification and the claims, a first server and/or a first processor that is recited as performing a first step or function may refer to the same or different server and/or a processor recited as performing a second step or function.

A “server computer” may typically be a powerful computer or cluster of computers. For example, the server computer can be a large mainframe, a minicomputer cluster, or a group of servers functioning as a unit. The server computer may be associated with an entity such as a payment processing network, a wallet provider, a merchant, an authentication cloud, an acquirer or an issuer. In one example, the server computer may be a database server coupled to a Web server. The server computer may be coupled to a database and may include any hardware, software, other logic, or combination of the preceding for servicing the requests from one or more client computers. The server computer may comprise one or more computational apparatuses and may use any of a variety of computing structures, arrangements, and compilations for servicing the requests from one or more client computers. In some embodiments or aspects, the server computer may provide and/or support payment network cloud service.

As used herein, the term “system” may refer to one or more computing devices or combinations of computing devices (e.g., processors, servers, client devices, software applications, components of such, and/or the like).

A “user” may include an individual. In some embodiments or aspects, a user may be associated with one or more personal accounts and/or mobile devices. The user may also be referred to as a cardholder, account holder, or consumer.

As used in any aspect herein, the term “logic” may refer to an app, software, firmware and/or circuitry configured to perform any of the aforementioned operations. Software may be embodied as a software package, code, instructions, instruction sets and/or data recorded on non-transitory computer readable storage medium. Firmware may be embodied as code, instructions or instruction sets and/or data that are hard-coded (e.g., nonvolatile) in memory devices.

As used in any aspect herein, the terms “component,” “system,” “module” and the like can refer to a computer-related entity, either hardware, a combination of hardware and software, software, or software in execution.

As used in any aspect herein, an “algorithm” refers to a self-consistent sequence of steps leading to a desired result, where a “step” refers to a manipulation of physical quantities and/or logic states which may, though need not necessarily, take the form of electrical or magnetic signals capable of being stored, transferred, combined, compared, and otherwise manipulated. It is common usage to refer to these signals as bits, values, elements, symbols, characters, terms, numbers, or the like. These and similar terms may be associated with the appropriate physical quantities and are merely convenient labels applied to these quantities and/or states.

A network may include a packet switched network. The communication devices may be capable of communicating with each other using a selected packet switched network communications protocol. One example communications protocol may include an Ethernet communications protocol which may be capable of permitting communication using a Transmission Control Protocol/Internet Protocol (TCP/IP). The Ethernet protocol may comply or be compatible with the Ethernet standard published by the Institute of Electrical and Electronics Engineers (IEEE) titled “IEEE 802.3 Standard”, published in December 2008 and/or later versions of this standard. Alternatively or additionally, the communication devices may be capable of communicating with each other using an X.25 communications protocol. The X.25 communications protocol may comply or be compatible with a standard promulgated by the International Telecommunication Union-Telecommunication Standardization Sector (ITU-T). Alternatively or additionally, the communication devices may be capable of communicating with each other using a frame relay communications protocol. The frame relay communications protocol may comply or be compatible with a standard promulgated by Consultative Committee for International Telegraph and Telephone (CCITT) and/or the American National Standards Institute (ANSI). Alternatively or additionally, the transceivers may be capable of communicating with each other using an Asynchronous Transfer Mode (ATM) communications protocol. The ATM communications protocol may comply or be compatible with an ATM standard published by the ATM Forum titled “ATM-MPLS Network Interworking 2.0” published August 2001, and/or later versions of this standard. Of course, different and/or after-developed connection-oriented network communication protocols are equally contemplated herein.

Unless specifically stated otherwise as apparent from the foregoing disclosure, it is appreciated that, throughout the present disclosure, discussions using terms such as “processing,” “computing,” “calculating,” “determining,” “displaying,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

One or more components may be referred to herein as “configured to,” “configurable to,” “operable/operative to,” “adapted/adaptable,” “able to,” “conformable/conformed to,” etc. Those skilled in the art will recognize that “configured to” can generally encompass active-state components and/or inactive-state components and/or standby-state components, unless context requires otherwise.

Those skilled in the art will recognize that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that typically a disjunctive word and/or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A and B.”

With respect to the appended claims, those skilled in the art will appreciate that recited operations therein may generally be performed in any order. Also, although various operational flow diagrams are presented in a sequence(s), it should be understood that the various operations may be performed in other orders than those which are illustrated, or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

It is worthy to note that any reference to “one aspect,” “an aspect,” “an exemplification,” “one exemplification,” and the like means that a particular feature, structure, or characteristic described in connection with the aspect is included in at least one aspect. Thus, appearances of the phrases “in one aspect,” “in an aspect,” “in an exemplification,” and “in one exemplification” in various places throughout the specification are not necessarily all referring to the same aspect. Furthermore, the particular features, structures or characteristics may be combined in any suitable manner in one or more aspects.

As used herein, the singular form of “a”, “an”, and “the” include the plural references unless the context clearly dictates otherwise.

Any patent application, patent, non-patent publication, or other disclosure material referred to in this specification and/or listed in any Application Data Sheet is incorporated by reference herein, to the extent that the incorporated materials is not inconsistent herewith. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein will only be incorporated to the extent that no conflict arises between that incorporated material and the existing disclosure material. None is admitted to be prior art.

In summary, numerous benefits have been described which result from employing the concepts described herein. The foregoing description of the one or more forms has been presented for purposes of illustration and description. It is not intended to be exhaustive or limiting to the precise form disclosed. Modifications or variations are possible in light of the above teachings. The one or more forms were chosen and described in order to illustrate principles and practical application to thereby enable one of ordinary skill in the art to utilize the various forms and with various modifications as are suited to the particular use contemplated. It is intended that the claims submitted herewith define the overall scope.

What is claimed is:

1. A method for securely communicating sensitive information on a client device, the method comprising:
receiving, by a client device, sensitive information;
determining, by an application running on the client device, a positive enablement status of a screen reader on the client device;
determining, by the application, a negative connection status of the client device to an audio device;
prompting, by the client device, to connect an audio device to the client device based on the negative connection status determination;
triggering, by the application, a number of wait periods;
determining, by the application, a persistence of the negative connection status after each period of the number of wait periods; and
prompting, by the client device, to input a passcode via the client device based on the persistence of the negative connection status determination.

2. The method of claim 1, further comprising authenticating, by the client device, a user of the client device via multifactor authentication (MFA).

3. The method of claim 2, wherein the MFA comprises biometric identification information of the user.

4. The method of claim 1, further comprising:
determining, by the application, a positive connection status of the client device to an audio device; and
playing, by the screen reader, a screen reading of the sensitive information on the client device via the audio device based on the positive connection status determination.

5. The method of claim 1, further comprising:
determining, by the application, a positive connection status of the client device to an audio device after a period of the number of wait periods;
playing, by the screen reader, a screen reading of the sensitive information on the client device via an audio device based on the positive connection status determination; and
terminating, by the application, any remaining wait periods of the number of wait periods based on the positive connection status determination.

6. The method of claim 1, further comprising:
determining, by the application, a negative enablement status of a screen reader on the client device; and
displaying, by the client device, the sensitive information on a display of the client device.

7. The method of claim 1, further comprising:
prompting, by the application, to input the passcode via the client device based on the persistence of the negative connection status after a last wait period of the number of wait periods;
receiving, by the client device, the passcode;
verifying, by the client device, the passcode; and
displaying, by the client device, the sensitive information on the client device based on a verification of the passcode.

8. The method of claim 1, further comprising:
determining, by a proximity sensor of the client device, a relative position of the client device to a user of the client device based on the negative connection status, wherein the relative position is within an operable position; and
playing, by the screen reader, a screen reading of the sensitive information by an audio device connected to the client device based on the relative position being within the operable position, wherein at least one of a volume or a spatial direction of the screen reading is based on the relative position.

9. The method of claim 1, further comprising:
determining, by a proximity sensor of the client device, a relative position of the client device to a user of the client device based on the negative connection status, wherein the relative position is within one of an operable position or an inoperable position; and
triggering, by the application, a prompting protocol based on the relative position being within the inoperable position.

10. The method of claim 9, wherein the prompting protocol comprises:
prompting, by the client device, to position the client device in a certain position;
detecting, by the proximity sensor, a change in the relative position;
determining, via the proximity sensor, a new relative position of the client device to the user;
playing, by the screen reader, a screen reading of the sensitive information based on the new relative position being within the operable position; and
terminating, by the client device, the prompting protocol based on the new relative position being within the operable position.

11. The method of claim 10, further comprising:
generating, by the client device, an updated audio prompt instruction comprising a prompt to position the client device in a certain position or a different user position based on the new relative position being within an inoperable position.

12. The method of claim 9, wherein the prompting comprises instructions to connect, move, or orientate at least one of the client device or the audio device.

13. The method of claim 9, further comprising:
playing, by the screen reader, a screen reading of the sensitive information based on the relative position being within the operable position.

14. A system for securely communicating sensitive information on a client device, the system comprising:
a terminal device or online platform;
a client device comprising a wireless interface; and
a server coupled to the client device and the terminal device or the online platform, wherein the server facilitates communication between the client device and the terminal device or the online platform;
wherein the client device is configured to:
determine a positive enablement status of a feature or option on the client device;
determine a negative connection status of the client device to an audio device based on the positive enablement status determination;
trigger a number of wait periods;
determine a connection status of the client device to an audio device after at least one wait period of the number of wait periods; and
playing a screen reading of sensitive information, generating a prompt, terminating the number of wait periods, or continuing the number of wait periods based on the connection status after the at least one wait period.

15. The system of claim 14, wherein the client device is further configured to connect via the wireless interface to the server to communicate with the terminal device or the online platform.

16. The system of claim 14, wherein the client device is further configured to:
transmit the connection status to the terminal device or the online platform; and
receive an authentication request or sensitive information from the terminal device or the online platform.

17. The system of claim 14, wherein the terminal device or the online platform is configured to:
transmit the sensitive information to the client device based on a successful authentication of a user or a connection status of the client device to the audio device.

18. A method for securely communicating sensitive information on a client device, the method comprising:
unmasking, by a client device, sensitive information using a multifactor authentication (MFA);
detecting, by an application running on the client device, an enablement status of a screen reader/talk back feature of the client device;
determining, by the application, a status of a user of the client device based on the enablement status of the screen reader/talk back feature of the client device;
determining, by the application, the status of the user to be a regular user based on the enablement status being disabled;
determining, by the application, the status of the user to be an impaired user based on the enablement status being enabled, based on the enablement status being enabled, the method further comprises:
determining, by the application, a connection status between the client device and an audio device; and
providing, by the client device, feedback based on the connection status between the client device and the audio device.

19. The method of claim 18, further comprising reading out, by the client device, the sensitive information based on the connection status between the client device and the audio device being connected.

20. The method of claim 18, further comprising prompting, by the client device, connect the audio device to the client device or locate the client device close to an ear of a user of the client device.
